(19) United States
(12) Patent Application Publication
(10) Pub. No.: US 2022/0388183 A1
(43) Pub. Date: Dec. 8, 2022

(54) GRIPPER DEVICE FOR A ROBOT GRIPPER AND METHOD FOR OPERATING A GRIPPER DEVICE

(71) Applicant: Deutsches Zentrum für Luft-und Raumfahrt e.V., Bonn (DE)

(72) Inventors: Roman WEITSCHAT, Weßling (DE); Martin GÖRNER, München (DE)

(21) Appl. No.: 17/773,335

(22) PCT Filed: Nov. 13, 2020
(86) PCT No.: PCT/EP2020/082165

§ 371 Date: Apr. 29, 2022

(30) Foreign Application Priority Data
Nov. 13, 2019 (DE) 102019130648.5

(51) Int. Cl. B25J 15/08; B25J 15/06; B25J 15/04

(52) U.S. Cl. CPC B25J 15/08; B25J 15/06; B25J 15/04

(57) ABSTRACT

The invention relates to a gripper device for a robot gripper, wherein the gripper device comprises a mechanical actuation with at least two contact elements guided linearly and in parallel in a direction of actuation, at least one mechanically activatable and/or deactivatable functional portion for objects to be gripped, and a transmission with at least two levers for converting a mechanical actuation power, and wherein the at least two contact elements on the one hand and the at least two levers on the other hand are each articulated to each other with a degree of freedom f=2. The invention also relates to a gripper device for a robot gripper with a mechanical actuation with at least two contact elements guided linearly and in parallel in a direction of actuation, at least one mechanically activatable and/or deactivatable functional portion for objects to be gripped, and a transmission for converting a mechanical actuation power, in which the transmission comprises a shaft for transferring a rotary motion and/or a torque, and to a method for operating gripper devices of this kind, wherein a gripper device is initially selected, then picked up from a predetermined position, then used and subsequently deposited at a predetermined position.

### CROSS-REFERENCE TO RELATED APPLICATIONS

The present application is a National Stage Entry of International Application Number PCT/EP2020/082165, filed Nov. 13, 2020, which claims the benefit of German Application Number DE1020191.30648.5, filed Nov. 13, 2019, the disclosures of which are hereby incorporated by reference in their entireties.

### FIELD OF THE INVENTION

The invention relates to gripper devices for a robot gripper. In addition the invention relates to a method for operating a gripper device.

### BACKGROUND OF THE INVENTION

From German patent application filed on 20 Sep. 2019 with reference number 10 2019 125 439.6 a gripper jaw for a robot gripper is known, wherein the gripper jaw has a first gripper jaw interface corresponding with the robot gripper and a second gripper jaw interface corresponding with tools of a toolset and the gripper jaw interfaces are used respectively as a mechanical interface, a signal interface and/or as a power interface.

Document DD 239 156 A1 relates to a vacuum lifter for lifting and manipulating workpieces. The vacuum lifter has a housing, a receiving surface, actuation members and an element which directly generates a vacuum. The actuation members are arranged inside the housing at an angle or axially to the receiving surface and adapted to gripper jaws of a gripper of an industrial robot. Sliding elements are used as actuation members for example, which are connected via toggle levers to a lifting rod, or a cross bolt is used for example which is connected directly to the lifting rod. The lifting rod belongs to the vacuum-generating element, which is configured as a membrane or similar element. The vacuum lifter can be picked up and operated directly by means of the gripper of an industrial robot.

The invention is based on the problem of improving an aforementioned gripper device structurally and/or functionally. In addition, the invention is based on the problem of improving an aforementioned method.

### SUMMARY OF THE INVENTION

The problem is solved by a gripper device having the features of claim 1. In addition, the problem is solved by a gripper device having the features of claim 6. Furthermore, the problem is solved by a method for operating a gripper device having the features of claim 13. Advantageous embodiments and/or developments are the subject-matter of the dependent claims.

The gripper device can be used for arranging on a robot gripper. The gripper device can be actuated by means of a robot gripper. The robot gripper can be used as an effector of a robot. The robot gripper can be a mechanical robot gripper. The robot gripper can have at least two gripping sections which can be displaced relative to one another in a gripper-opening/closing direction. The gripping sections can be displaced linearly, parallel to one another, in particular coaxially. The gripping sections can be used to apply an actuating movement and/or actuating force to the contact elements of the gripper device. The gripping sections can be used to pick up, actuate and/or deposit the gripper device. The robot gripper can be a finger gripper. The robot gripper can be a two-finger or multi-finger gripper. The robot gripper can have a rigid, rigid-jointed or elastic configuration. The robot gripper can be driven mechanically, pneumatically or electrically. The gripper device can be used for picking up, holding and/or depositing gripping objects.

The mechanical actuation can be used for actuating the gripper device. The mechanical actuation can be used for actuating the gripper device by means of a robot gripper. The mechanical actuation can be used for arranging the gripper device on a robot gripper. The mechanical actuation can be operated on two sides. The mechanical actuation can be centring when actuated. The mechanical actuation can be self-centring when actuated. The mechanical actuation can be used for actuating in an actuation direction. The actuation direction can correspond to a gripper opening/closing direction.

The gripper device can have a base. The gripper device can have a first support element and a second support element. The first support element and the second support element can be displaced relative to one another. The first support element and the second support element can be displaced towards one another and away from one another. The first support element can be used as a base. The second support element can be used as a lifting element.

The gripper device can have at least two levers. The at least two levers can each act between the first support element and the second support element. The at least two levers can each be pivotably mounted. The at least two levers can each be mounted fixed or loosely on the first support element. The at least two levers can each be mounted on the first support element in a simply supporting manner. The at least two levers can each be mounted fixed on the second support element. The at least two levers can each be mounted on the second support element by means of a bearing pin. The at least two levers can each be designed in one piece. The at least two levers can each be designed as angle levers. The at least two levers can each have two ends. The at least two levers cab each have an angled portion. The at least two levers can be rod-shaped or arc-shaped respectively. The at least two levers can each be designed as multiple parts. The at least two levers can each be configured as toggle levers. The at least two levers can each have two legs which are connected to one another in an articulated manner.

The at least two levers can each be supported directly on the first support element. The at least two levers can each be support directly on the second support element. The at least two levers can be connected by articulation to the second support element with a degree of freedom f=2. The at least two levers can each be in contact with the second support element on one side. The at least two levers can have active sections. The active sections can be centring when actuated. The active sections can be automatically centering when actuated.

The actuation can correspond with the robot gripper in a force-fitting and/or form-fitting manner. The actuation can correspond with the robot gripper in a geometrically complementary manner. The at least two contact elements can have at least approximately parallel contact surfaces. The at least two contact elements can be guided with their contact surfaces parallel. The at least two contact elements can be guided coaxially. The at least two contact elements can be guided on the first support element. The at least two contact elements can be guided in actuation direction. The first support element can have a linear guide for the at least two contact elements.

The contact elements can each be arranged at one end of a lever. The at least two contact elements on the one hand and the at least two levers on the other hand can each be connected to one another by means of a rotational sliding joint.

The active section can be used to form an active pairing with gripping objects. The active section can be activated and/or deactivated by mechanical actuation of the gripper device. The active section can be activated and/or deactivated by an activation/deactivation movement. The activation/deactivation movement can be a linear movement. The activation/deactivation movement can be a rotational movement. An activation/deactivation movement can be performed in an activation/deactivation direction. An activation/deactivation direction can be perpendicular to an actuation direction. An activation/deactivation movement can be about an activation/deactivation axis. An activation/deactivation axis can be perpendicular to an actuation direction. The at least one active section can be mechanically form-fitting, mechanically force-fitting, pneumatically, magnetically and/or adhesively active. The at least one active section can have a magnet arrangement with at least one permanent magnet, at least one scraper, at least one elastic element and/or at least one suction element. A plurality of permanent magnets can be arranged in a stack. The at least one scraper can have flat underside. The at least one scraper can have at least one opening for the at least one permanent magnet. The at least one permanent magnet can be adjusted by activating the gripper device between an active position and/or a deactive position. The at least one permanent magnet can be adjusted by lifting and/or lowering between an active position and/or a deactive position. The at least one permanent magnet can be adjusted by rotating between an active position and/or a deactive position. The at least one elastic element can include silicone. The at least one elastic element can be deformed by actuating the gripper device. The at least one suction element can have a suction cup. The at least one suction element can be evacuated by activating the gripper device. The at least one active section can be in the form of cutting pliers, syringes, riveting tools or safety cutting tools that only extend in a safe area. The gripper device can be configured as a surface gripper, an individual gripper, an internal gripper, an external gripper or a bottle gripper.

The transmission can be used for converting an actuation movement into an activation/deactivation movement. The transmission can be used for converting a linear movement in actuation direction into a linear movement in activation/deactivation direction. The transmission can be used for converting a linear movement in actuating direction into a rotational activation/deactivation movement. The transmission can be used for convening a parallel movement into a movement for activating and/or deactivating the at least one active section. The transmission can be used for converting a parallel movement into a movement of the first support element and the second support element relative to one another. The transmission can be used for converting a parallel movement into a movement of the at least one permanent magnet, into a movement of the at least one scraper, into a deformation of the at least one elastic element and/or into an evaluation of the at least one suction element. The transmission can be self-locking. The transmission can be self-locking when the active section is activated.

The shaft can be mounted on the base. The transmission can have cranks arranged on the shaft. The transmission can have coupling links connected by articulation to the cranks. The coupling links can each be articulated on the one hand to a crank and on the other hand to a contact element. The coupling links can each be articulated on the one hand to a crank and on the other hand to a lever. The coupling links can be arcuate.

The transmission can have at least one toothing. The transmission can have a gear and at least one rack. The transmission can have at least two racks. The gear can be arranged on the shaft. The at least two racks can be assigned to the at least two contact elements.

The gripper device can have a spring device. The spring device can be used to act on the at least one active section against an actuating force. The spring device can be used to push the at least one active section in the direction of deactivation. The spring device can act between the first support element and the second support element. The spring device can have at least one spring element. The at least one spring element can include rubber, silicone or a metal spring.

For gripping a gripping object, a robot gripper can grip the gripper device on actuation and move the gripper device with its at least one active section onto active contact with a gripping object. Then the contact elements can be applied towards one another by means of the robot gripper. The levers can pivot, move the first support element and the second support element away from one another and activate the at least one active section. On deactivating the at least one active section the first support element and the second support element can be moved towards each other again, if necessary caused or supported by the spring device.

A gripping state can be assessed by means of an actuating force. Based on the actuating force, it can be judged whether a gripping object is gripped securely or has been gripped incorrectly.

In summary and in other words, the invention provides among other things a robot actuated mechanism for actuating robot manipulators and a method for operating the latter.

A mechanically actuated gripper tool can be actuated by means of a two-linger parallel robot gripper, in order to thus perform a task such as suction gripping, magnet gripping, pipette tasks etc. A double-sided actuated mechanism can be centred with a uniform transmission of force through the robot gripper. A singular position can be made possible by a wide deflection of the lever (90°). Thus for example a suction force can be maintained without the need for further force to be introduced by the gripper. By means of the gripping force the secure gripping with the tool can be identified or a faulty grip can be identified.

By means of the invention the flexibility and/or effectiveness is increased. Tensions are avoided. The actuation force is reduced. Starting with a basic module an individualisation or adjustment is made possible. The investment, such as expenditure, is reduced. The invention can be used in particular in all industrial fields, in the logistics and packaging industry and/or in collaborative robotics.

### BRIEF DESCRIPTION OF THE FIGURES

In the following embodiments of the invention are described in more detail with reference to the figures, which show schematically and by way of example:

FIG. 1 a magnetically acting gripper device for a robot gripper in sectional view from the front,

FIG. 2 a magnetically acting gripper device for a robot gripper in sectional view from the rear.

FIG. 3 a gripper device designed as an internal gripper for a robot gripper with a deactivated elastic active section,

FIG. 4 a gripper device designed as an internal gripper for a robot gripper with an activated elastic active section,

FIG. 5 a robot gripper and a gripper device designed as a surface gripper with suction elements in a view from above,

FIG. 6 a robot gripper and a gripper device designed as a surface gripper with suction elements in a view from below,

FIG. 7 a gripper device designed as a suction litter for a robot gripper with a deactivated active section,

FIG. 8 a gripper device designed as a suction lifter for a robot gripper with an activated active section,

FIG. 9 a gripper device designed as a suction litter for a robot gripper with a deactivated active section in sectional view,

FIG. 10 a gripper device designed as a suction lifter for a robot gripper with an activated active section in sectional view,

FIG. 11 a gripper device designed as a suction lifter for a robot gripper with a deactivated active section in sectional view,

FIG. 12 a gripper device designed as a suction lifter for a robot gripper with an activated active section in sectional view,

FIG. 13 a robot with a robot gripper and a gripper device designed as a suction lifter,

FIG. 14 a gripper device with two levers designed as toggle levers,

FIG. 15 a gripper device with a shaft, cranks and coupling links,

FIG. 16 a gripper device with a shaft and toothing,

FIG. 17 a gripper device with a shaft, cranks, coupling links and levers,

FIG. 18 a gripper device with a rotatable magnet arrangement in a deactive position and

FIG. 19 a gripper device with a rotatable magnet arrangement in an active position.

### DETAILED DESCRIPTION OF THE FIGURES

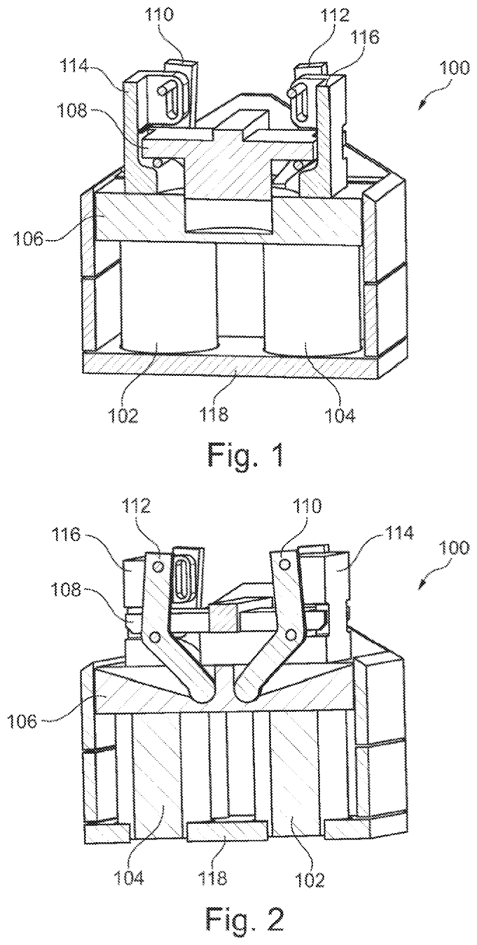

FIG. 1 shows a magnetically acting gripper device 100 in sectional view from the front. FIG. 2 shows the gripper device 100 in sectional view from the rear. The gripper device 100 is used for arrangement on a robot gripper, can be actuated by means of a robot gripper and is used for picking up, holding and/or depositing gripping objects.

The gripper device 100 has a mechanical actuation, two mechanically activatable and/or deactivatable active sections 102, 104 with permanent magnets for gripping objects and a transmission for converting a mechanical actuation power.

The mechanical actuation is used for arranging the gripper device 100 on a robot gripper and for actuating the gripper device 100 by means of the robot gripper. The mechanical actuation is activatable on two sides and is self centring when actuated.

The gripper device 100 has a first support element 106 used as a base and second support element 108 used as a lifting element, which are displaceable towards one another and away from one another.

The gripper device 100 has levers, such as 110, 112, acting between the first support element 106 and the second support element 108. The levers 110, 112 are configured as angled levers having two ends and an angled portion. The levers 110, 112 are each rotatable with their angled portion on the second support element 108 by means of a bearing pin and are otherwise mounted fixed and loosely in a simply supporting manner with one end on the first support element 106.

The actuation has two linearly guided contact elements 114, 116 with at least approximately parallel contact surfaces for the robot gripper. The contact elements 114, 116 are each arranged at one end of a lever 110, 112 by means of a rotational sliding joint.

The gripper device 100 has a scraper 118. The scraper 118 has a flat underside with openings for the permanent magnets. The permanent magnets are securely connected to the first support element 106. The scraper 118 is securely connected to the second support element 108.

For gripping a gripping object a robot gripper grips the gripper device 100 at the actuation and brings the gripper device 100 into operative contact with the gripping object by means of its active sections 102, 104. Then the contact elements 114, 116 are pressed towards one another by, means of the robot gripper. In doing so the levers 110, 112 pivot, the support elements 106, 108 move away from one another the permanent magnets move through the openings of the scraper 118 out of the underside, so that the active sections 102, 104 are activated. For deactivating the active sections 102, 104 conversely the permanent magnets are retracted back into the openings of the scraper 118 so that a gripping object is scraped.

The gripper device 100 is used for contacting a robotic parallel gripper for picking up the tool and symmetrically actuating the tool on both sides; friction-fitting and form-fitting, as well as centring. A parallel guide is used for transmitting force to levers 110, 112 via a pin. The levers 110, 112 are used for absorbing force and transmitting force from the contact elements 114, 116 to the first support element 106 via floating bearings, which can alternatively also be fixed bearings. Floating bearings enable a simple mounting and manufacturing via floating bearing bushes in the first support element 106. A force return or transmission of force takes place via pins into the second support element 108. A force is generated via a torque of the levers 110, 112, which is transmitted sinusoidally into the first support element 106 depending on the angle, which means that theoretically at an angle of about 90° enormously high forces can be transmitted. Thus e.g. the linearly increasing force of a spring is compensated and singularities are made possible. This means that the force on the scraper 118 is enabled and maintained even without further force transmission via the gripper device 100.

The second support element 108 is pulled back to its starting state by a spring element (rubber, silicone, metal spring, etc.) and also returns the levers 110, 112 back to their initial position.

A form closure connects the contact elements 114, 116 and the second support element 108 to one another so that the whole gripper device 100 is fixed and stabilised.

The gripper device 100 is a mechanically actuated magnetic gripping system. The permanent magnets are arranged at the end on column-shaped fixed connected spacers. The compression of the mechanism causes the lifting of the scraper 118 and causes the permanent magnets to protrude downwards and thus grip metallic/magnetic objects. The scraper 118 is moved downwards by a spring, which for example is located between the spacers and pushes the first support element 106 and the scraper 118 apart. This means that the distance between the permanent magnets and magnetic object is increased and thus the force of attraction also approaches 0. In this way a magnetic object can be picked up and put down again by pushing together and letting it rise up.

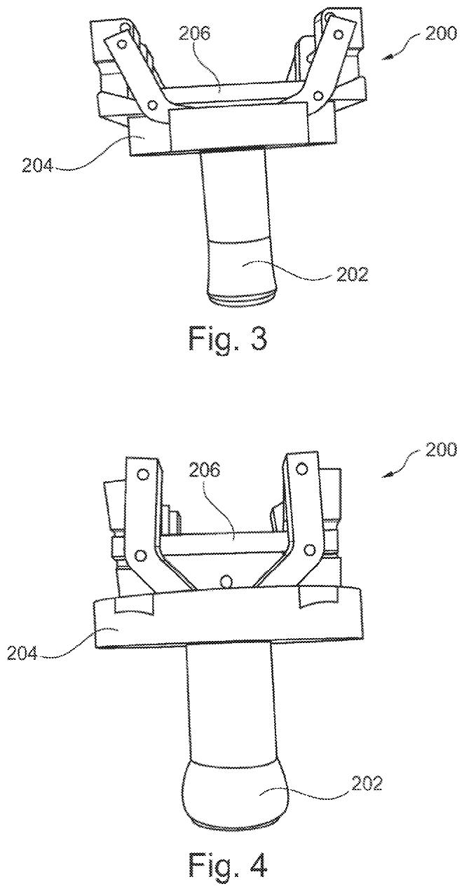

FIG. 3 shows a gripper device 200 designed as an internal gripper for a robot gripper with a deactivated elastic active section 202. FIG. 4 shows the gripper device 200 with the activated elastic active section 202.

When the first support element 204 and the second support element 206, as shown in FIG. 4, are moved away from one another, the elastic active section 202 is pushed together axially and deflects radially, so that there is an increase in diameter and the active section 202 is activated for example in order to grip a bottle. When the first support element 204 and the second support element 206, as shown in FIG. 3, are moved towards one another, the elastic active section 202 is relaxed axially and the diameter decreases again so that the active section 202 is deactivated. Furthermore, reference is made in particular to Ft 1 and FIG. 2 and the associated description.

By actuating the mechanism a silicone is compressed via an internal guide. This expands and thus makes it possible to grip e.g. bottles or other bores from the inside.

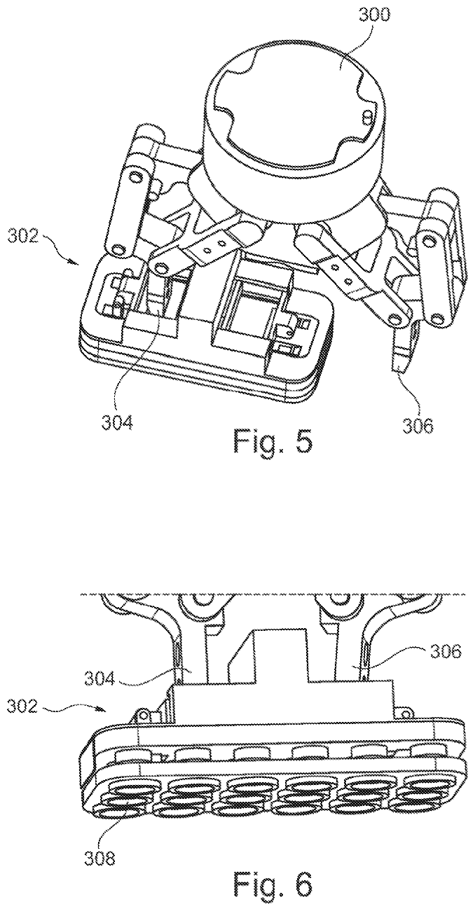

FIG. 5 shows a robot gripper 300 and a gripper device 302 designed as a surface gripper with suction elements in a view from above, FIG. 6 shows the robot gripper 300 and the gripper device 302 in a view from below.

The robot gripper 300 is used as an effector of a robot. Robot gripper 300 is a two-finger gripper with two gripping fingers 304, 306, The gripping fingers 304, 306 cooperate with the actuation of the gripper device 302.

The suction elements are arranged in a plane and are used as active sections, such as 308. When the first support element and the second support element are moved away from one another, the suction elements are evacuated or pressured with negative pressure and the active sections 308 are activated. When the first support element and the second support element are moved towards one another the suction elements are released again and the active section 308 is deactivated. Furthermore, reference is made in particular to FIG. 1 and FIG. 2 and the associated description.

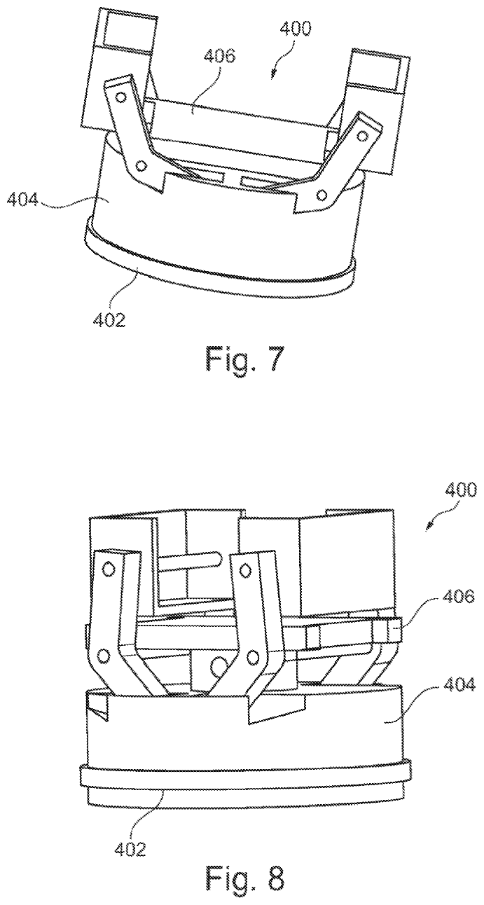

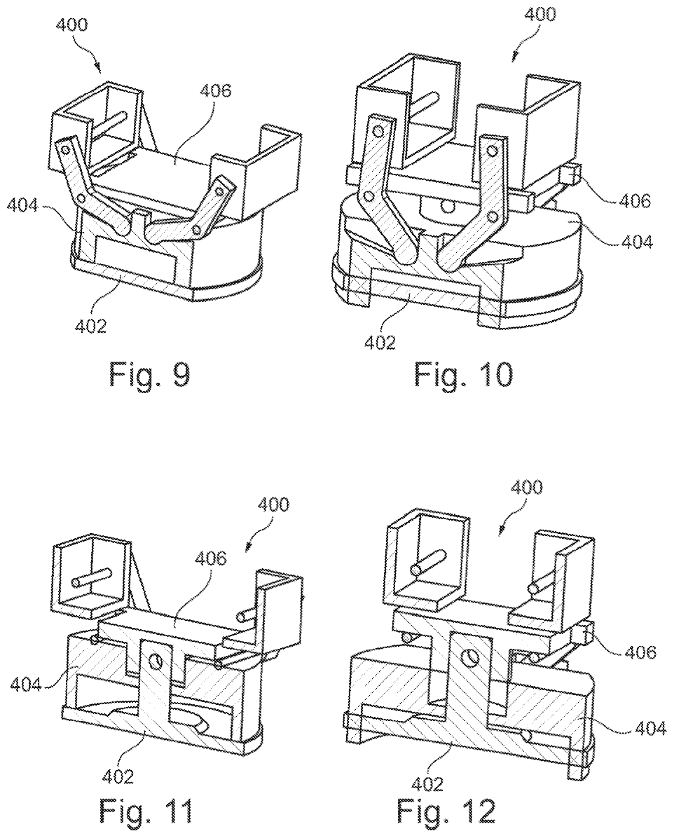

FIG. 7 shows a gripper device 400 designed as a suction lifter for a robot gripper with a deactivated active section 402. FIG. 8 shows the gripper device 400 with an activated active section 402. FIG. 9 shows the gripper device 400 with a deactivated active section 402 in sectional view. FIG. 10 shows the gripper device 400 with an activated active section 402 in sectional view. FIG. 11 shows the gripper device 400 with a deactivated active section 402 in a further sectional view. FIG. 12 shows the gripper device 400 with activated active section 402 in a further sectional view.

A suction element is used as an active section 402. The suction element has a plunger-like form and is securely connected to the second support element 406. When the first support element 404 and the second support element 406 are moved away from one another, the suction element is evacuated or subjected to negative pressure and the active section 402 is activated. When the first support element 404 and the second support element 406 are moved towards one another the suction element is released again and the active section 402 is deactivated. Furthermore, reference is made in particular to FIG. 1 and FIG. 2 and the associated description.

By extending a two-jaw gripper attached to a robot with the gripper device 400 a plate for example, that cannot be gripped with the two-jaw gripper, can be transported or handled. Afterwards the gripper device 400 can be put down again.

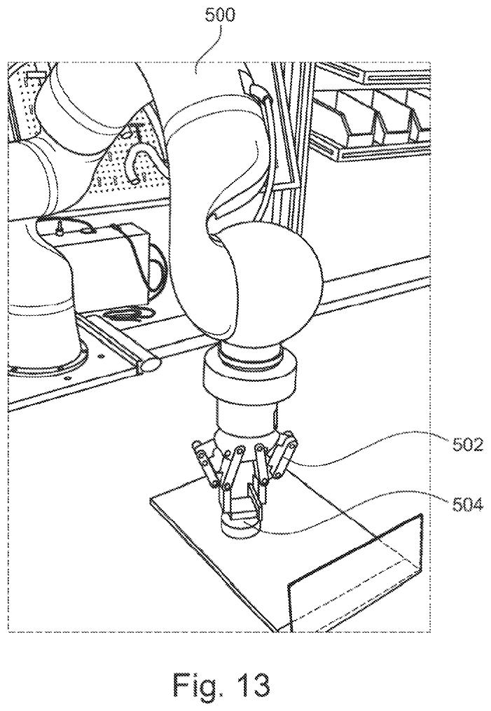

FIG. 13 shows a robot 500 with a robot gripper 502 and a gripper device 504 designed as a suction lifter. Furthermore, reference is made in particular to FIG. 1 and FIG. 2 and FIG. 7 to FIG. 12 and the associated description. The following steps can be performed: start up; grip gripper device 504; actuate gripper device 504, position gripping object; put gripper device 504 back down.

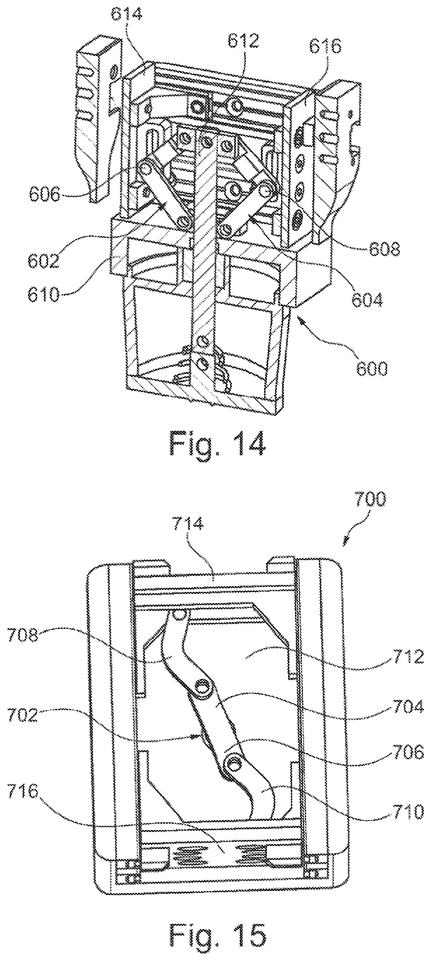

FIG. 14 shows a gripper device 600 with two multi-part levers 602, 604 designed as toggle levers. The levers 602, 604 each have two legs that are rod-shaped. The legs are each connected to each other by means of a swivel joint 606, 608. The levers 602, 604 each have a first end, which is connected by articulation to the first support element 610, and a second end, which is connect by articulation to the second support element 612. The contact elements 614, 616 are guided linearly on the first support element 610 in an actuating direction. The swivel joints 606, 608 each have an axis of rotation which is guided linearly on the contact elements 614, 616 in an activation/deactivation direction perpendicular to the actuating direction. Furthermore, reference is made in particular to FIG. 1, FIG. 2 and FIG. 7 to FIG. 12 and the associated description.

FIG. 15 shows a gripper device 700 with a shaft 702, cranks 704, 706 and arc-shaped coupling links 708, 710. The shaft 702 is mounted rotatably on a base 712. The cranks 704, 706 are arranged securely on the shaft 702. The coupling links 708, 710 are articulated on the one hand to a crank 704, 706 and on the other hand to a contact element 714, 716. The contact elements 714, 716 are guided linearly on the base 712 in an actuating direction. The transmission converts a linear movement of the contact elements 714, 716 into a rotational activation/deactivation movement. Furthermore, reference is made in particular to FIG. 1 and FIG. 2 and the associated description.

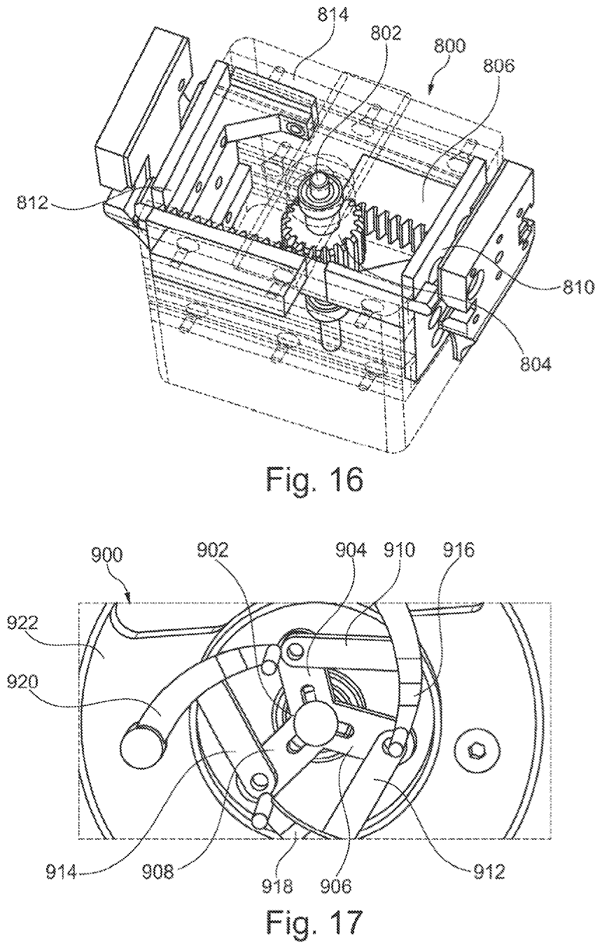

FIG. 16 shows a gripper device 800 with a shaft 802 and a toothing. The toothing is formed by means of a gear 804, which is securely connected to the shaft 802, and two racks, such as 806, which are each securely connected to a contact element 810, 812. The contact elements 810, 812 are guided linearly on the base 814 in an actuating direction. The transmission converts a linear movement of the contact elements 810, 812 into a rotational activation/deactivation movement. Furthermore, reference is also made in particular to FIG. 1 and FIG. 2 and the associated description.

FIG. 17 shows a gripper device 900 with a shaft 902, cranks 904, 906, 908, coupling links 910, 912, 914 and levers 916, 918, 920. The shaft 902 is mounted rotatably on a base 922. The cranks 904, 906, 908 are fixed onto the shaft 902. The coupling links 910, 912, 914 are each pivotably connected on the one hand to a crank 904, 906, 908 and on the other hand to a lever 916, 918, 920. The transmission converts a rotational activation/deactivation movement into spreading movement. Furthermore, reference is made in particular to FIG. 1, FIG. 2 and FIG. 16 and the associated description.

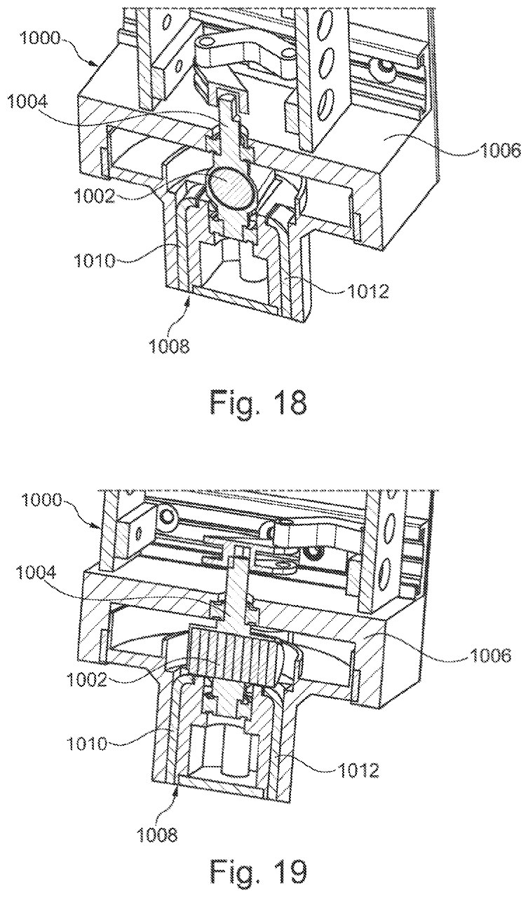

FIG. 18 shows a gripper device 1000 with a rotatable magnet arrangement 1002 in a deactivated position. FIG. 19 shows the gripper device 1000 in an active position. The gripper device 1000 has a shaft 1004, which is rotatably mounted on a base 1006. The magnet arrangement 1002 is fixed to the shaft 1004 and has permanent magnets arranged in a stack. Magnetic field conducting elements 1010, 1012 are arranged between the active section 1008 and the magnet arrangement 1002. In the active position a magnetic field of the magnet arrangement 1002 is conducted to the active section 1008 via the magnetic field conducting element 1010, 1012. In the deactivated position the magnetic field of the magnet arrangement 1002 is decoupled from the magnetic field conducting elements 1010, 1012 and its magnetic field is diverted by means of ferromagnetic elements so that the active section 1008 is free of magnetic force.

The term “can” denotes in particular optional features of the invention. Accordingly, there are also developments and/or embodiments of the invention, which additionally or alternatively have the respective feature or the respective features.

From the combinations of features disclosed here, if necessary also individual features can also be picked out and used in combination with other features to delimit the subject matter of the claims while resolving any structure and/or functional relationship between the features.

### LIST OF REFERENCE SIGNS

100 gripper device
102 active section
104 active section
106 first support element
108 second support element
110 lever
112 lever
114 contact element
116 contact element
118 scraper
200 gripper device
202 active section
204 first support element
206 second support element
300 robot gripper
302 gripper device
304 gripping finger
306 gripping finger
308 active section
400 gripper device
402 active section
404 first support element
406 second support element
500 robot
502 robot gripper
504 gripper device
600 gripper device
602 lever
604 lever
606 swivel joint
608 swivel joint
610 first support element
612 second support element
614 contact element
616 contact element
700 gripper device
702 shaft
704 crank
706 crank
708 coupling link
710 coupling link
712 base
714 contact element
716 contact element
800 gripper device
802 shaft
804 gear
806 rack
810 contact element
812 contact element
814 base
900 gripper device
902 shaft
904 crank
906 crank
908 crank
910 coupling link
912 coupling link
914 coupling link
916 lever
918 lever
920 lever
922 base
1000 gripper device
1002 magnet arrangement
1004 shaft
1006 base
1008 active section
1010 magnetic field control element
1012 magnetic field control element

1. A gripper device for a robot gripper, the gripper device having a mechanical actuation with at least two contact elements guided linearly in parallel in an actuation direction, at least one mechanically activatable and/or deactivatable active section for gripping objects, and a transmission with at least two levers for converting a mechanical actuating power, wherein the at least two contact elements and the at least two levers are each connected to one another in an articulated manner with a degree of freedom f=2.

2. The gripper device according to claim 1, wherein the at least two contact elements and the at least two levers are each connected to one another by means of a rotational sliding joint.

3. The gripper device according to claim 1, wherein the gripper device comprises a first support element and a second support element displaceable relative to one another, and the at least two levers are each supported directly on the first support element and directly on the second support element.

4. The gripper device according to claim 3, wherein the at least two levers are each connected by articulation to the second support element with a degree of freedom f=2.

5. The gripper device according to claim 1, wherein the at least two levers are each configured in one piece or as multiple parts.

6. A gripper device for a robot gripper, the gripper device having a mechanical actuation with at least two contact elements guided linearly in parallel in actuation direction, at least one mechanically activatable and/or deactivatable active section for gripping objects, and a transmission for converting a mechanical actuating power, wherein the transmission has a shaft for transmitting a rotary movement and/or a torque.

7. The gripper device according to claim 6, wherein the transmission has cranks arranged on the shaft and coupling links connected in an articulated manner to the cranks.

8. The gripper device according to claim 6, wherein the transmission has at least one toothing.

9. The gripper device according to claim 1, wherein the at least one active section is mechanically form-fitting, mechanically force-fitting, pneumatically, magnetically and/or adhesively active.

10. The gripper device according to claim 1, wherein the at least one active section comprises at least one permanent magnet, at least one elastic element and/or at least one suction element.

11. The gripper device according to claim 1, wherein the gripper device is configured as a surface gripper, as an individual gripper, as an internal gripper or as an external gripper.

12. The gripper device according to claim 1, wherein the gripper device has a spring device acting between the first support element and the second support element.

13. A method for operating a gripper device according to claim 1, wherein a gripper device is firstly selected, then picked up from a predetermined position, then used and then deposited in a predetermined position.

14. The method according to claim 13, wherein a gripping state is assessed on the basis of an actuating force.

15. The gripper device according to claim 1, further including at least two gripping sections which can be displaced relative to one another in a gripper-opening/closing direction to apply an actuating force to the at least two contact elements.

16. The gripper device according to claim 2, wherein the gripper device comprises a first support element and a second support element displaceable relative to one another, and the at least two levers are each supported directly on the first support element and directly on the second support element.

17. The gripper device according to claim 16, wherein the at least two levers are each connected by articulation to the second support element with a degree of freedom f=2.

18. The gripper device according to claim 1, wherein the at least two contact elements are guided coaxially.

19. The gripper device according to claim 1, further including a first support element and a second support element displaceable relative to one another, wherein the at least two contact elements are guided on the first support element.

20. The gripper device according to claim 1, wherein the at least one active section is activated and/or deactivated by an activation/deactivation movement performed in a direction that is perpendicular to the actuation direction of the at least two contact elements.
